(19) United States
(12) Patent Application Publication
(10) Pub. No.: US 2024/0342656 A1
(43) Pub. Date: Oct. 17, 2024

(54) SUSTAINABLE ENERGY-BASED CONTACTLESS REVERSE OSMOSIS (CRO) BY LOW ENERGY PUMP FOR SMART PORTABLE WATER FILTRATION SYSTEM

(71) Applicant: THE TEXAS A&M UNIVERSITY SYSTEM, College Station, TX (US)

(72) Inventors: Shuza BINZAID, College Station, TX (US); Kazi Meharajul KBIR, College Station, TX (US)

(21) Appl. No.: 18/632,858

(22) Filed: Apr. 11, 2024

Related U.S. Application Data
(60) Provisional application No. 63/458,534, filed on Apr. 11, 2023.

(51) Int. Cl. B01D 61/08; B01D 61/02; B01D 61/12; C02F 1/00; C02F 1/44; C02F 103/00

(52) U.S. Cl. CPC B01D 61/08; B01D 61/025; B01D 61/12; C02F 1/008; C02F 1/441; B01D 2313/243; B01D 2313/367; B01D 2313/60; C02F 2103/001; C02F 2201/009; C02F 2209/03; C02F 2209/10; C02F 2209/42

(57) ABSTRACT

The present disclosure provides a water filtration system that meets the need for production of clean, potable water. In particular, described herein is a system comprising a Pressure Energy Transformer (PET), a Contactless Reverse Osmosis (CRO) pump, and an intelligent microcontroller-based system that provides contactless energy transfer for the production of clean drinking water.

### CROSS-REFERENCE TO RELATED APPLICATIONS

This application claims the benefit under 35 U.S.C. § 119(e) of U.S. Provisional Application Ser. No. 63/458,534, filed on Apr. 11, 2023, the entire disclosures of which is incorporated herein by reference.

### BACKGROUND AND SUMMARY

The scarcity of clean, quality drinking water is a global crisis. For instance, in rural and underdeveloped regions, the primary drinking water sources can include surface-collected water such as pond water, tube well water, or rainwater. The production of drinking water from these unsafe sources remains a challenge in these communities.

The most common process utilized for water purification is reverse osmosis (RO), in which pressurized water passes through a special filter using a pump. Although high-power pumps are efficient and do not require frequent maintenance, the amount of energy necessary to operate such a pump can be challenging in rural and underdeveloped regions. Use of low-power pumps require less energy to operate but are problematic due to sediment buildup from unclean water damaging the internal components of the pumps. Therefore, there exists a need for new systems and methods for water purification that require less power to operate, are durable and reliable, and provide cost-effective options.

Accordingly, the present disclosure provides a water filtration system that meets the demanding need for this problem. In particular, described herein is a system comprising a Pressure Energy Transformer (PET), a Contactless Reverse Osmosis (CRO) pump, and an intelligent microcontroller-based system that provides contactless energy transfer for the production of clean drinking water. Advantageously, the systems described herein are portable and capable of being solar powered to provide low-cost rainwater purification with a durable pump for long-lasting effects.

Importantly, the systems provide microcontroller codes to adapt the system to sustainable living. Typically, water filtration systems requires a large amount of power (e.g., 400-500 watts) to control the water pump. As a result, a sustainable power solution for home can become overburdened due to the amount of energy needed for the reverse osmosis filtration process. Moreover, although a low-power solution using about 30-50 watts is also available in the market, the low-power pump must contact the water that is processed by filtration, resulting in contamination by sediments and requiring frequent maintenance.

The systems described herein provide a long-lasting service at a very low investment for power. The system is less expensive, so the common underserved communities, remote areas, and people living off the grid have access to filtered, drinkable water in order to improve health and safety. In addition, the described system can save lives in disaster areas by being self-powered system and ensuring cleaner water for drinking.

Other objects, features and advantages of the present disclosure will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTIONS OF THE DRAWINGS

The detailed description particularly refers to the accompanying figures in which:

FIG. 1 shows a design of an exemplary embodiment of the water filtration system.

FIG. 2 shows a flowchart of the functions of the CRO water filtration system.

FIG. 3 shows an exemplary embodiment of the water filtration system.

### DETAILED DESCRIPTION

Various embodiments of the invention are described herein as follows. In an illustrative aspect, a water filtration system is provided. The water filtration system comprises i) a pressure energy transformer (PET) module; ii) a contactless reverse osmosis (CRO) pump; iii) a water filter; iv) a microcontroller; v) a first reservoir configured for containing a first liquid; vi) a second reservoir configured for containing a second liquid; and vii) a third reservoir configured for containing a third liquid.

In an embodiment, the first liquid is rainwater. In an embodiment, the rainwater is collected from the environment.

In an embodiment, the second liquid is potable water. In an embodiment, the potable water is processed from the rainwater. In an embodiment, the potable water comprises a TDS of less than 30 ppm. In an embodiment, the potable water comprises a TDS of less than 25 ppm. In an embodiment, the potable water comprises a TDS of less than 20 ppm. In an embodiment, the potable water comprises a TDS of less than 15 ppm. In an embodiment, the potable water comprises a TDS of less than 10 ppm.

In an embodiment, the third liquid is water. In an embodiment, the water is deionized water.

In an embodiment, the water filter is a reverse osmosis (RO) filter. In an embodiment, the water filter is configured to convert the first liquid into the second liquid. In an embodiment, the water filter is a NSF42 type filter.

In an embodiment, the PET module is coupled to the water filter. In an embodiment, the PET module is configured to reduce water pressure in the water filtration system. In an embodiment, the reduction in water pressure is from a first value of 100 psi to a second value between 20 psi to 50 psi.

In an embodiment, the CRO pump is coupled to the water filter. In an embodiment, the CRO pump is coupled to the microcontroller. In an embodiment, the CRO pump does not contact the first liquid. In an embodiment, the CRO pump does not contact the second liquid.

In an embodiment, the CRO pump is capable of being powered using less than 50 watts. In an embodiment, the CRO pump is capable of being powered using less than 40 watts. In an embodiment, the CRO pump is capable of being powered using less than 30 watts. In an embodiment, the CRO pump is capable of being powered using less than 20 watts.

In an embodiment, the CRO pump is capable of pumping 10 gallons of liquid per minute. In an embodiment, the CRO pump is capable of pumping 20 gallons of liquid per minute. In an embodiment, the CRO pump is capable of pumping 30 gallons of liquid per minute.

In an embodiment, the microcontroller comprises software.

In an embodiment, the first reservoir comprises a first sensor. In an embodiment, the first sensor is configured to detect presence of the first liquid in the first reservoir or a level of the first liquid in the first reservoir. In an embodiment, the first sensor is a pressure sensor. In an embodiment, the first sensor is coupled to the microcontroller. In an embodiment, the first sensor is waterproof.

In an embodiment, the first reservoir comprises a second sensor. In an embodiment, the first sensor is configured to detect presence of the first liquid in the first reservoir or a level of the first liquid in the first reservoir. In an embodiment, the second sensor is a pressure measurement sensor. In an embodiment, the second sensor is coupled to the microcontroller. In an embodiment, the second sensor is waterproof.

In an embodiment, the second reservoir comprises a third sensor. In an embodiment, the third sensor is configured to detect presence of the second liquid in the second reservoir or a level of the second liquid in the second reservoir. In an embodiment, the third sensor is a pressure sensor. In an embodiment, the third sensor is coupled to the microcontroller. In an embodiment, the third sensor is waterproof.

In an embodiment, the second reservoir comprises a fourth sensor. In an embodiment, the fourth sensor is a pressure sensor. In an embodiment, the fourth sensor is coupled to the microcontroller. In an embodiment, the fourth sensor is waterproof.

In an embodiment, the water filtration system further comprises an input for a renewable energy source. In an embodiment, the input for a renewable energy source comprises one or more solar panels. In an embodiment, the solar panel is below 60 watts. In an embodiment, the solar panel is below 50 watts. In an embodiment, the solar panel is below 40 watts. In an embodiment, the solar panel is below 30 watts. In an embodiment, the solar panel is below 20 watts.

In an embodiment, the input for a renewable energy source comprises an integrated charging station. In an embodiment, the integrated charging station is an integrated EWeC (energy, water, and e-bike) charging station. In an embodiment, the integrated charging station is an integrated EWC (energy and water) charging station. Charging stations include those described in WO2023/225473 and WO2023/225474, both of which are incorporated herein by reference in their entireties.

In an embodiment, the water filtration system further comprises a digital display. In an embodiment, the water filtration system further comprises a battery. In an embodiment, the battery is a lithium battery. In an embodiment, the battery is coupled to the microcontroller.

In an embodiment, the battery is coupled to an input for a renewable energy source. In an embodiment, the input for a renewable energy source comprises one or more solar panels. In an embodiment, the input for a renewable energy source comprises an integrated charging station. In an embodiment, the integrated charging station is an integrated EWeC (energy, water, and e-bike) charging station. In an embodiment, the integrated charging station is an integrated EWC (energy and water) charging station.

In an embodiment, the water filtration system is a portable system. In an embodiment, the water filtration system is an automated system. In an embodiment, the water filtration system is a contactless system. As used herein, a contactless system refers to non-contact of the CRO pump to either the first liquid or the second liquid, thereby reducing or eliminating contamination of the CRO pump. In an embodiment, the water filtration system is configured to provide contactless energy transfer.

In an illustrative aspect, a method of filtering water using the water filtration system of any of the described embodiments is provided.

The following numbered embodiments are contemplated and are non-limiting:
1. A water filtration system comprising:
   i) a pressure energy transformer (PET) module;
   ii) a contactless reverse osmosis (CRO) pump;
   iii) a water filter;
   iv) a microcontroller;
   v) a first reservoir configured for containing a first liquid;
   vi) a second reservoir configured for containing a second liquid; and
   vii) a third reservoir configured for containing a third liquid.
2. The water filtration system of clause 1, any other suitable clause, or any combination of suitable clauses, wherein the first liquid is rainwater.
3. The water filtration system of clause 2, any other suitable clause, or any combination of suitable clauses, wherein the rainwater is collected from the environment.
4. The water filtration system of clause 1, any other suitable clause, or any combination of suitable clauses, wherein the second liquid is potable water.
5. The water filtration system of clause 4, any other suitable clause, or any combination of suitable clauses, wherein the potable water is processed from the rainwater.
6. The water filtration system of clause 4, any other suitable clause, or any combination of suitable clauses, wherein the potable water comprises a TDS of less than 30 ppm.
7. The water filtration system of clause 4, any other suitable clause, or any combination of suitable clauses, wherein the potable water comprises a TDS of less than 25 ppm.
8. The water filtration system of clause 4, any other suitable clause, or any combination of suitable clauses, wherein the potable water comprises a TDS of less than 20 ppm.
9. The water filtration system of clause 4, any other suitable clause, or any combination of suitable clauses, wherein the potable water comprises a TDS of less than 15 ppm.
10. The water filtration system of clause 4, any other suitable clause, or any combination of suitable clauses, wherein the potable water comprises a TDS of less than 10 ppm.
11. The water filtration system of clause 1, any other suitable clause, or any combination of suitable clauses, wherein the third liquid is water.
12. The water filtration system of clause 11, any other suitable clause, or any combination of suitable clauses, wherein the water is deionized water.
13. The water filtration system of clause 1, any other suitable clause, or any combination of suitable clauses, wherein the water filter is a reverse osmosis (RO) filter.
14. The water filtration system of clause 1, any other suitable clause, or any combination of suitable clauses, wherein the water filter is configured to convert the first liquid into the second liquid.
15. The water filtration system of clause 1, any other suitable clause, or any combination of suitable clauses, wherein the water filter is a NSF42 type filter.
16. The water filtration system of clause 1, any other suitable clause, or any combination of suitable clauses, wherein the PET module is coupled to the water filter.
17. The water filtration system of clause 1, any other suitable clause, or any combination of suitable clauses, wherein the PET module is configured to reduce water pressure in the water filtration system.
18. The water filtration system of clause 17, any other suitable clause, or any combination of suitable clauses, wherein the reduction in water pressure is from a first value of 100 psi to a second value between 20 psi to 50 psi.
19. The water filtration system of clause 1, any other suitable clause, or any combination of suitable clauses, wherein the CRO pump is coupled to the water filter.
20. The water filtration system of clause 1, any other suitable clause, or any combination of suitable clauses, wherein the CRO pump is coupled to the microcontroller.
21. The water filtration system of clause 1, any other suitable clause, or any combination of suitable clauses, wherein the CRO pump does not contact the first liquid.
22. The water filtration system of clause 1, any other suitable clause, or any combination of suitable clauses, wherein the CRO pump does not contact the second liquid.
23. The water filtration system of clause 1, any other suitable clause, or any combination of suitable clauses, wherein the CRO pump is capable of being powered using less than 50 watts.
24. The water filtration system of clause 1, any other suitable clause, or any combination of suitable clauses, wherein the CRO pump is capable of being powered using less than 40 watts.
25. The water filtration system of clause 1, any other suitable clause, or any combination of suitable clauses, wherein the CRO pump is capable of being powered using less than 30 watts.
26. The water filtration system of clause 1, any other suitable clause, or any combination of suitable clauses, wherein the CRO pump is capable of being powered using less than 20 watts.
27. The water filtration system of clause 1, any other suitable clause, or any combination of suitable clauses, wherein the CRO pump is capable of pumping 10 gallons of liquid per minute.
28. The water filtration system of clause 1, any other suitable clause, or any combination of suitable clauses, wherein the CRO pump is capable of pumping 20 gallons of liquid per minute.
29. The water filtration system of clause 1, any other suitable clause, or any combination of suitable clauses, wherein the CRO pump is capable of pumping 30 gallons of liquid per minute.
30. The water filtration system of clause 1, any other suitable clause, or any combination of suitable clauses, wherein the microcontroller comprises software.
31. The water filtration system of clause 1, any other suitable clause, or any combination of suitable clauses, wherein the first reservoir comprises a first sensor.
32. The water filtration system of clause 31, any other suitable clause, or any combination of suitable clauses, wherein the first sensor is configured to detect presence of the first liquid in the first reservoir or a level of the first liquid in the first reservoir.
33. The water filtration system of clause 31, any other suitable clause, or any combination of suitable clauses, wherein the first sensor is a pressure sensor.
34. The water filtration system of clause 31, any other suitable clause, or any combination of suitable clauses, wherein the first sensor is coupled to the microcontroller.
35. The water filtration system of clause 31, any other suitable clause, or any combination of suitable clauses, wherein the first sensor is waterproof.
36. The water filtration system of clause 1, any other suitable clause, or any combination of suitable clauses, wherein the first reservoir comprises a second sensor.
37. The water filtration system of clause 36, any other suitable clause, or any combination of suitable clauses, wherein the first sensor is configured to detect presence of the first liquid in the first reservoir or a level of the first liquid in the first reservoir.
38. The water filtration system of clause 36, any other suitable clause, or any combination of suitable clauses, wherein the second sensor is a pressure measurement sensor.
39. The water filtration system of clause 36, any other suitable clause, or any combination of suitable clauses, wherein the second sensor is coupled to the microcontroller.
40. The water filtration system of clause 36, any other suitable clause, or any combination of suitable clauses, wherein the second sensor is waterproof.
41. The water filtration system of clause 1, any other suitable clause, or any combination of suitable clauses, wherein the second reservoir comprises a third sensor.
42. The water filtration system of clause 41, any other suitable clause, or any combination of suitable clauses, wherein the third sensor is configured to detect presence of the second liquid in the second reservoir or a level of the second liquid in the second reservoir.
43. The water filtration system of clause 41, any other suitable clause, or any combination of suitable clauses, wherein the third sensor is a pressure sensor.
44. The water filtration system of clause 41, any other suitable clause, or any combination of suitable clauses, wherein the third sensor is coupled to the microcontroller.
45. The water filtration system of clause 41, any other suitable clause, or any combination of suitable clauses, wherein the third sensor is waterproof.
46. The water filtration system of clause 1, any other suitable clause, or any combination of suitable clauses, wherein the second reservoir comprises a fourth sensor.
47. The water filtration system of clause 46, any other suitable clause, or any combination of suitable clauses, wherein the fourth sensor is a pressure sensor.
48. The water filtration system of clause 46, any other suitable clause, or any combination of suitable clauses, wherein the fourth sensor is coupled to the microcontroller.
49. The water filtration system of clause 46, any other suitable clause, or any combination of suitable clauses, wherein the fourth sensor is waterproof.
50. The water filtration system of clause 1, any other suitable clause, or any combination of suitable clauses, wherein the water filtration system further comprises an input for a renewable energy source.
51. The water filtration system of clause 50, any other suitable clause, or any combination of suitable clauses, wherein the input for a renewable energy source comprises one or more solar panels.
52. The water filtration system of clause 51, any other suitable clause, or any combination of suitable clauses, wherein the solar panel is below 60 watts.
53. The water filtration system of clause 51, any other suitable clause, or any combination of suitable clauses, wherein the solar panel is below 50 watts.
54. The water filtration system of clause 51, any other suitable clause, or any combination of suitable clauses, wherein the solar panel is below 40 watts.
55. The water filtration system of clause 51, any other suitable clause, or any combination of suitable clauses, wherein the solar panel is below 30 watts.
56. The water filtration system of clause 51, any other suitable clause, or any combination of suitable clauses, wherein the solar panel is below 20 watts.
57. The water filtration system of clause 50, any other suitable clause, or any combination of suitable clauses, wherein the input for a renewable energy source comprises an integrated charging station.
58. The water filtration system of clause 57, any other suitable clause, or any combination of suitable clauses, wherein the integrated charging station is an integrated EWeC (energy, water, and e-bike) charging station.
59. The water filtration system of clause 57, any other suitable clause, or any combination of suitable clauses, wherein the integrated charging station is an integrated EWC (energy and water) charging station.
60. The water filtration system of clause 1, any other suitable clause, or any combination of suitable clauses, wherein the water filtration system further comprises a digital display.
61. The water filtration system of clause 1, any other suitable clause, or any combination of suitable clauses, wherein the water filtration system further comprises a battery.
62. The water filtration system of clause 61, any other suitable clause, or any combination of suitable clauses, wherein the battery is a lithium battery.
63. The water filtration system of clause 61, any other suitable clause, or any combination of suitable clauses, wherein the battery is coupled to the microcontroller.
64. The water filtration system of clause 61, any other suitable clause, or any combination of suitable clauses, wherein the battery is coupled to an input for a renewable energy source.
65. The water filtration system of clause 64, any other suitable clause, or any combination of suitable clauses, wherein the input for a renewable energy source comprises one or more solar panels.
66. The water filtration system of clause 64, any other suitable clause, or any combination of suitable clauses, wherein the input for a renewable energy source comprises an integrated charging station.
67. The water filtration system of clause 66, any other suitable clause, or any combination of suitable clauses, wherein the integrated charging station is an integrated EWeC (energy, water, and e-bike) charging station.
68. The water filtration system of clause 66, any other suitable clause, or any combination of suitable clauses, wherein the integrated charging station is an integrated EWC (energy and water) charging station.
69. The water filtration system of clause 1, any other suitable clause, or any combination of suitable clauses, wherein the water filtration system is a portable system.
70. The water filtration system of clause 1, any other suitable clause, or any combination of suitable clauses, wherein the water filtration system is an automated system.
71. The water filtration system of clause 1, any other suitable clause, or any combination of suitable clauses, wherein the water filtration system is a contactless system.
72. The water filtration system of clause 1, any other suitable clause, or any combination of suitable clauses, wherein the water filtration system is configured to provide contactless energy transfer.
73. A method of filtering water using the water filtration system of any one of clauses 1 to 72.

### EXAMPLES

### Example 1

### Design of Water Filtration System

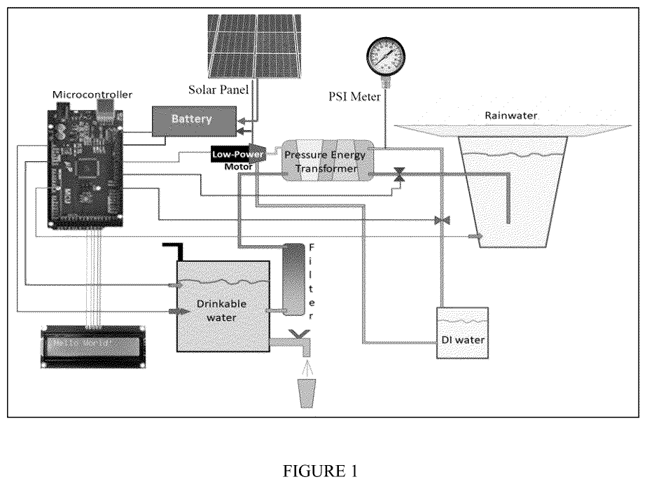

The instant example provides an exemplary design of an embodiment of the described water filtration system. FIG. 1 shows a design of the embodiment.

In the instant example, the water filtration system is solar-powered and comprises microcontroller-based smart electronics capable of running a low-power pump attached to PET for the CRO filtration process. The system is completely portable and easily accessible in any location. The system comprises two parts: a Hardware Integration for the CRO process and a Custom Software for CRO System.

For the Hardware Integration for the CRO process, the CRO Process includes (1) a low-power pump and (2) a PET module. The PET module includes a microcontroller with four sensors and three water control valves to operate the CRO process safely and also a rainwater collecting indicator LED (see FIG. 1). The energy for the system was supplied by solar energy via solar panels.

The reverse osmosis (RO) filter was selected for the exemplary system to be less than 60 psi. The system can use any low-cost microcontroller, for instance those with 5 analog and 7 digital pins. Logical operations for the code can be developed for system operation. The low-power pump can include a pressure sensor for instance one that is preset to 55 psi.

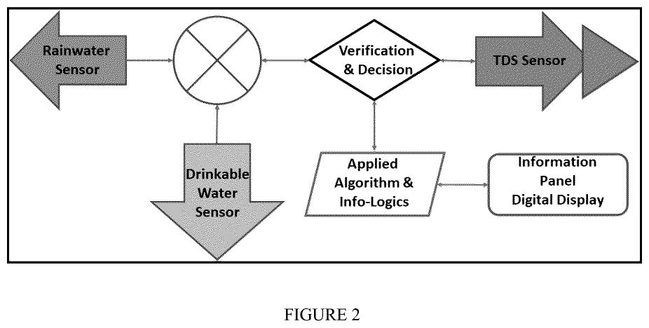

For the software for the CRO System, FIG. 2 shows a flowchart for several simple functions of the CRO system. The system can comprise four sensors and three control valves for processing information by the microcontroller, as well as a digital display panel for the user. Two water level sensors can indicate water availability in rainwater and filtered water reservoirs and logical output at the display can indicate the status of water levels in the tanks. An algorithm can be applied to a TDS sensor signal to display the filtered water purity status.

### Example 2

### Exemplary Water Filtration System

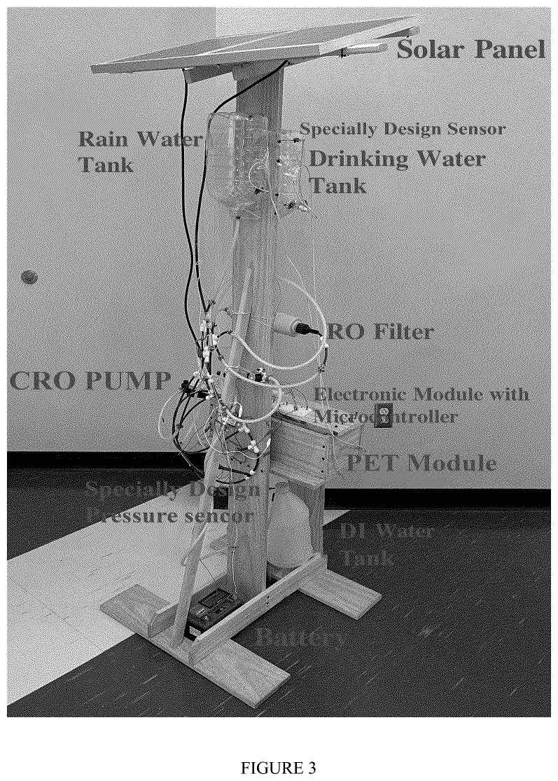

The instant example provides an exemplary embodiment of the described water filtration system. FIG. 3 shows the embodiment and the system components are listed in Table 1.

| Items | Specifications | Quantity |
|---|---|---|
| Solar Panel | 30 Wp | 2 Pcs |
| Charge Controller | 12 VDC and 5 A | 1 Pcs |
| Battery | 12 V and 10Ah | 1 Pcs |
| Low Power Pump Motor | 12 VDC and 4A or less | 1 Pcs |
| Relay Valve | 12 VDC and 0.2-0.4 A | 3 Pcs |
| Pressure Sensor | Set at 50 psi max | 1 Pcs |
| Water Sensor | Analog sensor | 4 Pcs |
| Microcontroller | Arduino Nano | 1 Pcs |
| Water Reservoir | 1-5 Gallon | 3 Pcs |
| PET Module | Range: 0.5-30 psi | 1 Pcs |
| RO Filter | 60 psi max, TDS: 10-25 ppm | 1 Pcs |
| Power Amplifier | MOSFET | 4 Pcs |
| Resistor | 10 kΩ | 4 Pcs |
| Diode | 1N4001 | 4 Pcs |
| LEDs | Multiple Colors | 5 Pcs |
| Water Tap | In-line | 1 Pcs |
| Cost of the total system | USD | 200.00 |
| Weight of the system | Empty | 24 lbs |

In the instant example, a portable solar-powered CRO rainwater filtration system was developed. The system comprises two solar panels, and each panel produced 30 Wₚ. The produced electricity was stored in the lithium-ion battery. The capacity of the battery was 12 volts and 10 A.

The system comprises three water reservoirs. The reservoirs include a rainwater collection tank, a fresh drinking water storage tank, and provided water tank for pressure control. Two sensors were included in the rainwater collection tank to sense and determine the water collection and level of water. Two sensors were established in the drinking water tank to determine the water level and the pump's operation.

A CRO filter was used to filter the rainwater into drinking water. A low-powered, high-pressure 12 VDC pump was used to complete the filtration process, and three control valves were used to control the water. A PET module was established to reduce the pressure of the system. A pressure sensor was established in the system to measure the system pressure. If the pressure of the system was higher than 55 psi, microcontroller will stop the operation of the pump. A coded program and an algorithm were developed for the system microcontroller in order to collect sensor data, valves, and pump operations and to make the system fully automated and contactless.

For operation of the CRO water filtration process of the system, 30 watts/hr were used via energy was supplied from the battery. The rainwater collection reservoir included two sensors as shown in FIG. 3. The first sensor of the rainwater collection reservoir (Sensor 1) was used to determine the rainwater collection status. If rain falls, Sensor 1 collected the value and then the LED would glow to indicate that rain was falling and the rainwater was accumulating in the rainwater reservoir. Otherwise, the LED would not glow.

The second sensor of the rainwater collection reservoir (Sensor 2) measured the water level of the rainwater collection tank. When the water level was lower than Sensor 2, information was supplied to the microcontroller. The microcontroller would then shut down the CRO water filtration operation because of the lack of input rainwater.

The main function of the CRO process was to reduce the pressure on the system. Initially, the pressure of the system was large (e.g., about 100 psi). Thus, a PET module was established as shown in FIG. 3. The main function of the PET was to reduce the 100 PSI to between 20-50 PSI. A pressure sensor is used in the 60 psi and the microcontroller would stop operation of the system (e.g., pump and valves).

The rainwater was purified by a CRO filter to produce potable (drinking) water, which was stored in the drinking water reservoir. The drinking water reservoir was equipped with two sensors as shown in FIG. 3 (i.e., Sensor 3 and Sensor 4). Sensor 3 was used for higher water level indication of the tank. After the level of potable water reached the highest level, Sensor 3 would transmit a signal to the microcontroller. Thereafter, the microcontroller would stop the water filtration process as soon as the water reached its lowest point. Sensor 4 transmitted the signal to the microcontroller and the water filtering process resumes. An algorithm was developed, and an encoded program was written into the microcontroller to make the entire process automated.

1. A water filtration system comprising:
i) a pressure energy transformer (PET) module;
ii) a contactless reverse osmosis (CRO) pump;
iii) a water filter;
iv) a microcontroller;
v) a first reservoir configured for containing a first liquid;
vi) a second reservoir configured for containing a second liquid; and
vii) a third reservoir configured for containing a third liquid.

2. The water filtration system of claim 1, wherein the first liquid is rainwater.

3. The water filtration system of claim 1, wherein the second liquid is potable water, wherein the potable water is processed from the rainwater.

4. The water filtration system of claim 1, wherein the third liquid is water, and wherein the water is deionized water.

5. The water filtration system of claim 1, wherein the water filter is a reverse osmosis (RO) filter.

6. The water filtration system of claim 1, wherein the water filter is configured to convert the first liquid into the second liquid.

7. The water filtration system of claim 1, wherein the PET module is coupled to the water filter.

8. The water filtration system of claim 1, wherein the PET module is configured to reduce water pressure in the water filtration system.

9. The water filtration system of claim 1, wherein the CRO pump is coupled to the water filter.

10. The water filtration system of claim 1, wherein the CRO pump is coupled to the microcontroller.

11. The water filtration system of claim 1, wherein the CRO pump does not contact the first liquid.

12. The water filtration system of claim 1, wherein the CRO pump does not contact the second liquid.

13. The water filtration system of claim 1, wherein the first reservoir comprises a first sensor and a second sensor.

14. The water filtration system of claim 1, wherein the second reservoir comprises a third sensor and a fourth sensor.

15. The water filtration system of claim 1, wherein the water filtration system further comprises an input for a renewable energy source, wherein the input for a renewable energy source comprises one or more solar panels.

16. The water filtration system of claim 1, wherein the water filtration system further comprises a battery.

17. The water filtration system of claim 1, wherein the water filtration system is a portable system.

18. The water filtration system of claim 1, wherein the water filtration system is an automated system.

19. The water filtration system of claim 1, wherein the water filtration system is a contactless system.

20. The water filtration system of claim 1, wherein the water filtration system is configured to provide contactless energy transfer.
